(19) United States
(12) Patent Application Publication
(10) Pub. No.: US 2013/0302764 A1
(43) Pub. Date: Nov. 14, 2013

(54) SYSTEM AND METHOD FOR SUBSTANCE ABUSE RECOVERY

(71) Applicants: Alan I. Stevens, Jupiter, FL (US); Michael Weiner, Palm Beach Gardens, FL (US)

(72) Inventors: Alan I. Stevens, Jupiter, FL (US); Michael Weiner, Palm Beach Gardens, FL (US)

(73) Assignee: Behavioral Health of the Palm Beaches, Inc., North Palm Beach, FL (US)

(21) Appl. No.: 13/469,138

(22) Filed: May 11, 2012

(51) Int. Cl. G09B 19/00

(52) U.S. Cl. 434/236

(57) ABSTRACT

Embodiments of the present invention generally relate to a system and method for substance abuse recovery. In accordance with an embodiment of the present invention, a system and method for substance abuse recovery in a central server is provided comprising: receiving a request for a recovery plan from at least a first user; providing a book associated with the recovery plan to at least the first user; administering an interactive session between at least the first user and at least a second user based on the recovery plan; and generating, at the central server, at least one record associated with at least the first user in a database in connection with the recovery plan.

### BACKGROUND

1. Field of the Invention

The following generally relates to a system and method for substance abuse recovery. More specifically, embodiments of the present invention relate to a system and method for substance abuse recovery that implement a twelve-step recovery plan designed to help those individuals who suffer from addictive diseases.

2. Description of Related Art

Millions of people around the world suffer from addictive diseases that relate to one or more substances. These addictive substances may include alcohol, caffeine, nicotine, tobacco-related products, opioids and cocaine, to name a few. Many individuals who use one or more of these substances develop physical and emotional dependencies on the drug(s), which can lead to a full addiction. Individuals suffering from these addictive diseases often experience a negative impact in various aspects of their lives, physically, socially, emotionally, spiritually, financially, academically, professionally, and legally. An individual's failure to recognize and treat an addictive disease may lead to further problems, including, but not limited to, a lowered self-esteem and problematic relationships with friends and family.

Those individuals suffering from addictive diseases often seek treatment by checking into one or more rehabilitation facilities, non-profit groups or other self-help organizations. In the art, SMART Recovery is an addiction recovery support group that utilizes a four-point program that aids individuals in coping with a wide variety of addictive diseases. Other well-known organizations include fellowships such as Alcoholics Anonymous and Narcotics Anonymous. These fellowships provide addicts of alcohol and drugs with a twelve-step program to help support one another and encourage sobriety among all individuals. One limitation of these twelve-step programs is that religious references are made throughout the twelve-steps to a higher Power such as God. As a result, many individuals suffering from addictive diseases may be hesitant or unwilling to enroll in Alcoholics Anonymous and/or Narcotics Anonymous meetings. This may be due to various reasons including, but not limited to, the individual's non-belief in a higher Power such as God or the individual's beliefs associated with a particular religious affiliation. This limitation in the twelve-step programs of Alcoholics Anonymous and Narcotics Anonymous limits the treatment options available to those individuals suffering from addictive diseases.

Another limitation of rehabilitation facilities and self-help organizations for those suffering from addictive diseases is that meetings are often held in environments that are not appealing to a broad range of individuals, e.g., rented space in office buildings or churches. These ordinary environments may inhibit the effectiveness of any addiction treatment program because many individuals may have a difficult time boosting their morale and well-being in these particular locales.

Thus, there is a need for an improved system and method for substance abuse recovery that appeals to a broader range of individuals by implementing a recovery plan comprising steps that focus on other individuals to aid in the recovery process rather than on a religious figure or higher Power such as God.

There is a further need for an improved system and method for substance abuse recovery that prepares individuals for entry into traditional substance abuse recovery programs. In the alternative, there is a need for an improved system and method for substance abuse recovery that serves as an adequate alternative for those who refuse to participate in Alcoholics Anonymous and Narcotics Anonymous programs.

Furthermore, there is a need for an improved system and method for substance abuse recovery that implements a recovery plan in an environment that is more conducive to boosting the morale and well-being of an individual over the typical office meeting room or church.

### SUMMARY

Embodiments of the present invention generally relate to a system and method for substance abuse recovery. In accordance with one embodiment of the present invention, there is provided a method of substance abuse recovery, the method comprising: receiving a request for a recovery plan from at least a first user; providing a book associated with the recovery plan to at least the first user; administering an interactive session between at least the first user and at least a second user based on the recovery plan; and generating, at a central server, at least one record associated with at least the first user in a database in connection with the recovery plan.

In accordance with yet another embodiment of the present invention, there is provided a system of substance abuse recovery comprising: a central server, accessible via a global computer network, the central server comprising a tangible computer readable medium comprising program instructions, wherein the program instructions are computer-executable to implement: receiving a request for a recovery plan from at least a first user; providing a book associated with the recovery plan to at least the first user; administering an interactive session between at least the first user and at least a second user based on the recovery plan; and generating, at the central server, at least one record associated with at least the first user in a database in connection with the recovery plan.

In accordance with yet another embodiment of the present invention, there is provided a system and method for substance abuse recovery that implements a recovery plan in an environment that is more conducive to boosting the morale and well-being of an individual suffering from an addictive disease.

### BRIEF DESCRIPTION OF THE DRAWINGS

So the manner in which the above recited features of the present invention may be understood in detail, a more particular description of embodiments of the present invention, briefly summarized above, may be had by reference to embodiments, several of which are illustrated in the appended drawings.

Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 depicts a system-level diagram of a system for substance abuse recovery in accordance with one embodiment of the present invention;

FIG. 2 depicts a block diagram of a general computer system, which is capable of being used in connection with the system depicted in FIG. 1, in accordance with another embodiment of the present invention;

FIG. 3 depicts a flowchart of an exemplary method for substance abuse recovery in accordance with the embodiments of the present invention; and

FIGS. 4A-4N depict various examples of a recovery plan to be used in a system and method for substance abuse recovery in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to.

### DETAILED DESCRIPTION

In the following detailed description, numerous specific details are set forth in order to provide a thorough understanding of embodiments or other examples described herein. In some instances, well-known methods, procedures, and components have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

As used herein, the terms “user” or “users” may generally refer to any person, group, entity, or electronic device capable of accessing or communicating with a network or server computer configured in accordance with an embodiment of the present invention and implementing or utilizing any embodiment of the present invention. For example, a “user” may be an individual person, a group of people, a company, a group of companies, other organizations or the like.

As used herein, the terms “substance” or “substances” may generally refer to any addictive item that may include, but is not limited to, caffeine, alcohol, nicotine, inhalants, prescription drugs, over-the-counter drugs, amphetamines, sedatives, opioids, cannabis, cocaine, hallucinogens, phencyclidine, or the like.

As used herein, the terms “addictive disease” or “addictive diseases” generally refer to any physical or mental dependency that an individual may experience with regards to one or more substance as defined above.

As used herein, the terms “health professional” or “medical professional” generally refer to a therapist, psychiatrist, health specialist, doctor, nurse, spiritual advisor, any staff member of a rehabilitation facility, self-help organization, or the like.

As used herein, the terms “computer” or “server” generally refer to devices that may comprise processors, program logic, or other substrate configurations representing data and instructions, which may operate as described herein. In other embodiments, the computers or servers may comprise controller circuitry, processor circuitry, processors, general purpose single-chip or multi-chip microprocessors, digital signal processors, embedded microprocessors, microcontrollers, integrated circuits, application specific integrated circuits, discrete logic, or the like. In yet other embodiments, the computers or servers may comprise hardware, firmware, software and/or other combinations of these to perform a function or an action, and/or to cause a function or action.

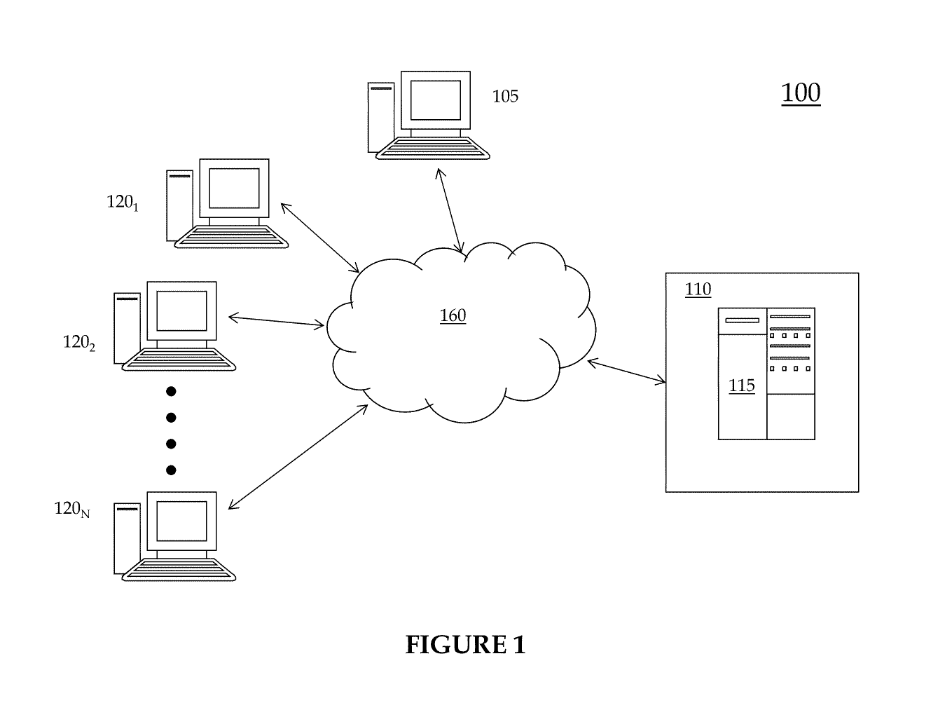

FIG. 1 depicts a basic system-level diagram of a substance abuse recovery system in accordance with one embodiment of the present invention. The system 100 generally comprises a second user 105 and first users 120₁, 120₂, and 120_{N}, each in communication with an administrator 110, generally hosting a central server 115 through a network 160. A substance abuse recovery communication in accordance with one or more embodiments of the present invention takes place over the network 160, which may comprise a global computer network, for example, the Internet.

Although FIG. 1 explicitly depicts three first users (labeled 120₁, 120₂, and 120_{N}), it should be appreciated that N represents any number of users feasible in accordance with embodiments of the present invention. For ease of reference, as used herein, the phrase “first user” may refer to any one or all of the users 120₁, 120₂, and 120_{N} within the system 100. Likewise, although FIG. 1 explicitly depicts only one second user 105, there may be more than one second user 105 in accordance with certain embodiments of the present invention. That is, in certain embodiments, multiple second users may perform the same or similar functions as the second user 105.

As understood by embodiments of the present invention, a user may include any person, business or entity, capable of participating in the system and methods disclosed herein. As used herein, the term “first user” may include, but is not limited to, a customer, client, patient or individual suffering from an addictive disease or drug dependency of any substance. As used herein, the term “second user” may include, but is not limited to, a therapist, psychiatrist, health specialist, doctor, nurse, spiritual advisor, medical professional or the like. In an alternative embodiment of the present invention, the term “second user” may be any staff member of a rehabilitation facility, self-help organization, or the like.

In accordance with an embodiment of the present invention, the first user 120₁, 120₂, or 120_{N} may be an individual who has experimented with, abused or become dependent on a substance. As a result, the first user 120₁, 120₂, or 120_{N} may suffer from an addictive disease in connection with the substance. As described in one or more embodiments of the present invention, the first user's addictive disease may relate to any one or more drugs such as caffeine, alcohol, nicotine, inhalants, prescription drugs, over-the-counter drugs, amphetamines, sedatives, opioids, cannabis, cocaine, hallucinogens, phencyclidine, or the like. In an alternative embodiment of the present invention, the first user's addictive disease may relate to one or more non-drug dependencies such as gambling or a habit.

In accordance with an embodiment of the present invention, the first user 120₁, 120₂, or 120_{N} seeks treatment for an addictive disease in connection to a recovery plan as described in various embodiments of the invention using system 100. In accordance with one or more embodiments of the present invention, a recovery plan comprises any series of steps that guide an individual suffering from an addictive disease through the recovery process. In an embodiment of the present invention, the recovery plan comprises a series of twelve-steps, which will be described in hereinafter. It shall be appreciated that any number of the twelve-steps may be further broken down into multiple steps or grouped together to form fewer steps. Further, although one or more steps may relate to one primary individual, it shall be appreciated that one or more individuals in addition to the primary individual may help to achieve the goals for each step.

It should be appreciated that the twelve-step recovery plan contemplated in one or more embodiments of the present invention may prepare a first user 120₁, 120₂, or 120_{N} for entry into a traditional rehabilitation program, such as Alcoholics Anonymous, Narcotics Anonymous or SMART recovery. In the alternative, it should be appreciated that the twelve-step recovery plan may serve as an adequate alternative to those who refuse to enroll in Alcoholics Anonymous, Narcotics Anonymous or SMART recovery.

In accordance with an embodiment of the present invention, in step 1 of the recovery plan, the first user 120₁, 120₂, or 120_{N} believes a substance has made his/her life unmanageable. Generally, a substance will render an individual's life unmanageable when the individual has decided to seek treatment at a rehabilitation facility and has realized that the substance has been a problem in his/her daily life. In the alternative, an individual's life may be unmanageable when the substance has had a negative impact on the individual's life physically, socially, spiritually, emotionally, professionally, academically, financially and legally. Further, additional factors that contribute to an unmanageable life include, but are not limited to, an individual's inability to maintain relationships with others, a lowered self-esteem, and a lack of honesty when communicating with others.

In accordance with an embodiment of the present invention, in step 2 of the recovery plan, the first user 120₁, 120₂, or 120_{N} believes that he/she needs outside support to address the user's unmanageable life and reclaim his/her life. As used herein, the term “outside support” may be, but is not limited to, any strength, support and/or resource that is not within the first user's control or possession. This may include one or more, books, videos, tutorials, articles, or advice and opinion from a health professional, or the like. In an embodiment of the present invention, support may be both physical and/or emotional. In determining whether a first user 120₁, 120₂, or 120_{N} is in need of outside support, a series of questions are often contemplated, such as: What have I done to try to control my use of alcohol or drugs and/or the consequences of that use? Has it worked? I'm smart, accomplished, I've worked hard, and I have many positive character traits. Why couldn't I solve this problem? Is my problem psychiatric? Lack of intelligence? What then?

In accordance with an embodiment of the present invention, in step 3 of the recovery plan, the first user 120₁, 120₂, or 120_{N} places trust in another user's input, wherein the another user has previously overcome the same obstacles that the first user faces in the recovery process for an addictive disease. In an embodiment of the present invention, the term “another user” may include any other individual who has previously suffered or is currently suffering from an addictive disease, counselor, or health professional. As used herein, the term “input” may include any collection of wisdom, knowledge, expertise, experience, or the like. In determining whether a first user 120₁, 120₂, or 120_{N} should place trust in another user's input, a series of questions are often contemplated, such as: Is it possible that something none of us have been able to do alone, we can do together? Is doing something together a power greater than ourselves? Am I willing to give another way a try? What is spirituality? Does spirituality have a place in my life? How do I practice spirituality? What's most important to me in my life? Can I achieve these if I keep drinking/drugging? If no, what am I willing to do to stop? Am I ready to try meetings of Alcoholics/Narcotics Anonymous or SMART Recovery? Am I willing to see a therapist as recommended? Will church have a role in my recovery? How will I re-engage with my family? What's going to help to make me remember why I've chosen to stay clean?

In accordance with an embodiment of the present invention, in step 4 of the recovery plan, the first user 120₁, 120₂, or 120_{N} acknowledges that he/she has made a fearless and comprehensive moral inventory of himself/herself. The goal of conducting a moral inventory is to help the first user 120₁, 120₂, or 120_{N} to achieve a moral recovery. As used herein, the term “moral inventory” is a review and analysis of the character traits and behaviors that have helped and hurt the first user and people that he/she cares about. Relevant character traits include, but are not limited to, honesty and dishonesty. A moral inventory of oneself is beneficial in the recovery process because it allows an individual to accept himself/herself as a positive person with both helpful and non-helpful traits. When conducting a moral inventory, a first user 120₁, 120₂, or 120_{N} will often contemplate a series of questions, such as: Who is the person we want to be? Can we live according to our own values if we continue to abuse substances? What is the solution?

In accordance with an embodiment of the present invention, in step 5 of the recovery plan, the first user 120₁, 120₂, or 120_{N} humbly admits his/her flaws to himself/herself and another person. In accordance with an embodiment of the present invention, “another person” may be any first user or second user as described in one or more embodiments of the present invention. As used herein, the term “flaw” may refer to any character trait or habit that may cause or relate to one or more addictive diseases. In humbly admitting one or more flaws, the first user 120₁, 120₂, or 120_{N} will often contemplate a series of questions, such as: Are we willing to accept help in dealing with our really negative behavior? What does it mean to be “humble”? Do you perceive being humble as a positive character trait?

In accordance with an embodiment of the present invention, in step 6 of the recovery plan, the first user 120₁, 120₂, or 120_{N} acknowledges a willingness to accept help in addressing his/her flaws. In an embodiment of the present invention, a first user 120₁, 120₂, or 120_{N} will contemplate a series of questions related to addressing such flaws, such as: Are we willing to accept help in dealing with our really negative behavior? Who are the people, groups, or organizations you would accept help from? Assuming that accepting help from others has helped us to stop abusing substances, can it also help us overcome other behaviors that have harmed us or others?

In accordance with an embodiment of the present invention, in step 7 of the recovery plan, the first user 120₁, 120₂, or 120_{N} tries to eliminate his/her shortcomings with openness and humility. In accordance with an embodiment of the present invention, the term “shortcoming” refers to any setback or flaw that may contribute to an addictive disease as described throughout the application.

In accordance with an embodiment of the present invention, in step 8 of the recovery plan, the first user 120₁, 120₂, or 120_{N} creates a list of users harmed by the first user 120₁, 120₂, or 120_{N} due to the first user's addictive disease. Each user in the list of users may refer to any one or more of the following including, but not limited to, another first user, second user, family member, or any other individual affected by the first user's addictive disease. In accordance with an embodiment of the present invention, harm in the form of physical pain, mental pain and/or anger may result from the first user's past behaviors and character traits related to an addictive disease.

In accordance with an embodiment of the present invention, in step 9 of the recovery plan, the first user 120₁, 120₂, or 120_{N} makes amends to each user in the list of users harmed. As used herein, the terms “amend” and “amends” generally refer to any action that attempts to repair or remedy the harm caused to each user in the list of users harmed. For example, a first user 120₁, 120₂, or 120_{N} may seek counseling to confront a family member or friend in order to improve a relationship that was fractured due to the first user's addictive disease. In accordance with an embodiment of the present invention, the first user 120₁, 120₂, or 120_{N} may contemplate one or more questions, such as: Are we humble enough to admit that some of these people are really people we care about? Is making amends to at least some of these people the right thing to do? Are the amends for me or the other person? Why do it?

In accordance with an embodiment of the present invention, in step 10 of the recovery plan, the first user 120₁, 120₂, or 120_{N} conducts a regular inventory of himself/herself and promptly admits when he/she is wrong. In an embodiment of the present invention, a regular inventory is conducted on a daily basis, consciously or unconsciously. The regular inventory process will allow the first user 120₁, 120₂, or 120_{N} to appreciate and develop a better understanding of any self-respect or self-loathing issues that may be present. An awareness of the first user's self-issues will help to develop, tailor and implement an effective substance abuse recovery program. In accordance with an embodiment of the present invention, the first user 120 may contemplate one or more questions when conducting a regular inventory, such as: Do you respect how you conducted your life today? If so, your self-respect goes up. If not, your self-respect goes down. Do you respect the person who lived today? Do you understand the task of putting many good days together?

In accordance with an embodiment of the present invention, in step 11 of the recovery plan, the first user 120₁, 120₂, or 120_{N} uses meditation and reflection to discover a positive path to follow in the first user's substance abuse recovery. In accordance with an embodiment of the present invention, the term “mediation” or “reflection” may include, but is not limited to, yoga, stretching, discussions with a health professional, or the like.

In accordance with an embodiment of the present invention, in step 12 of the recovery plan, the first user 120₁, 120₂, or 120_{N} shares any one or all of the aforementioned steps of the plan with at least another user to help the another user to reclaim his/her life. In accordance with an embodiment of the present invention, the term “another user” refers generally to any additional first user, second user, or more generally to any individual suffering from an addictive disease.

System 100 of FIG. 1 may be utilized to implement the system and method for substance abuse recovery as disclosed in one or more embodiments of the present invention. It should be noted, however, any transmission system, capable of transmitting bytes of data from a first device to a second device, over any physical medium, may be utilized in accordance with embodiments of the present invention.

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G, 4G and 4G LTE Advanced telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

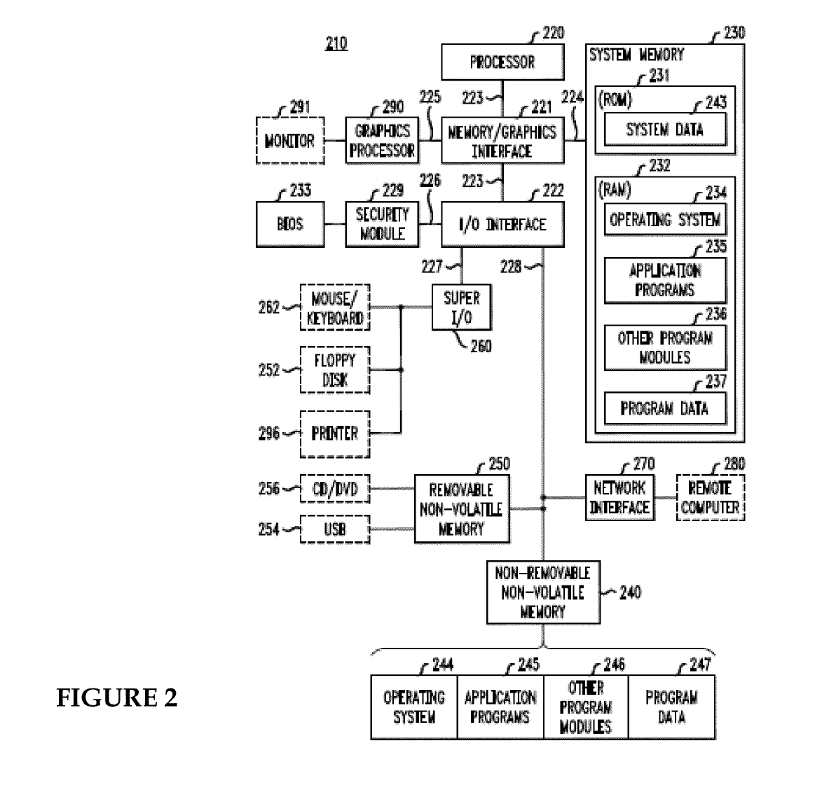

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

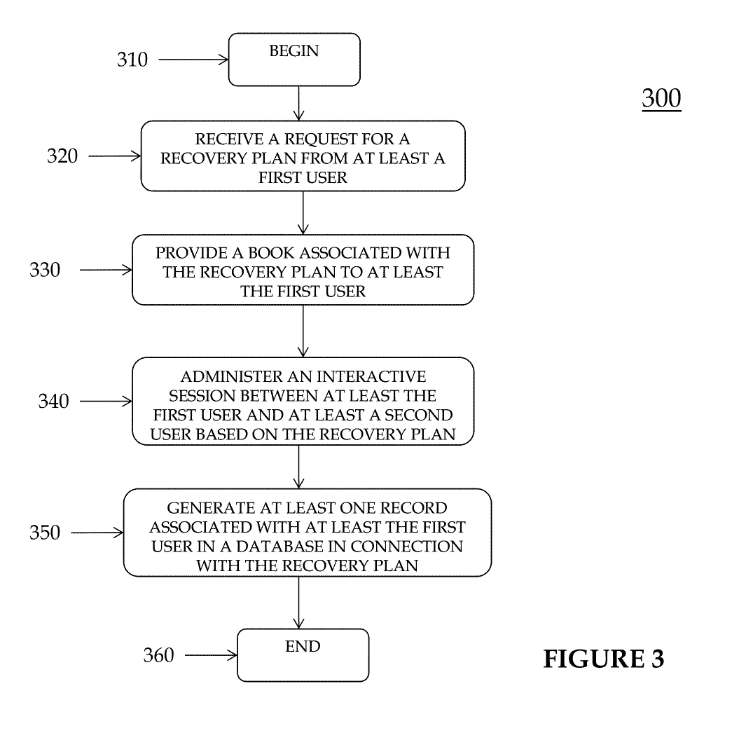

FIG. 3 depicts a flowchart of a method for substance abuse recovery implemented in a central server in accordance with an embodiment of the present invention. For convenience, the method 300 is described with reference to system 100 of FIG. 1. The method 300 may be carried out within other system architectures known in the art as well.

The method 300 begins at step 310. At step 320, a second user 105 receives a request for a recovery plan from a first user 120₁, 120₂, or 120_{N} via network 160. The first user 120₁, 120₂, or 120_{N} may create a request for a recovery plan by enabling a software application using a general purpose computer, as described above, or mobile computing device. The mobile device in the context of this application may include, but is not limited to, an Apple iPhone, iPad, a Blackberry device, an Android device, mobile e-tablets, Personal Data Assistants (PDA) or the like, or may generally include a general purpose computer. In one or more embodiments of the present invention, the software application is accessible to the first user 120₁, 120₂, or 120_{N} through the network 160, e.g., through a website available on the Internet. In other embodiments, the first user's mobile device may be preprogrammed with such software application upon purchase or obtaining the mobile device. In an alternative embodiment of the present invention, the first user 120₁, 120₂, or 120_{N} may make a face-to-face request for a recovery plan to the second user while attending a rehabilitation facility, office building, or other public locale.

At step 330, a second user 105 provides a book associated with the recovery plan to a first user 120₁, 120₂, or 120_{N}. As used herein, the term “book” may refer to any book, electronic book, workbook, pocket handbook, or the like, that contains the twelve-step recovery plan as described in one or more embodiments of the present invention. In accordance with an embodiment of the present invention, the second user 105 may transmit the book to the first user 120₁, 120₂, or 120_{N} via network 160 using any of the transmission means described in embodiments of the invention or known in the art. In an alternative embodiment, second user 105 may physically hand the book to the first user in a rehabilitation facility or other public locale.

At step 340, a second user 105 administers an interactive session between a first user 120₁, 120₂, or 120_{N} and the second user 105 based on the recovery plan. In one or more embodiments of the present invention, the phrase “interactive session” may refer to any discussion that occurs between the first user and the second user with regards to the recovery plan. For example, the interactive session may be a daily meeting between the first user 120₁, 120₂, or 120_{N} and second user 105 at a rehabilitation facility, in which the second user 105 explains and assists the first user in learning and understanding the twelve-steps of the recovery plan as described in one or more embodiments of the present invention. In an alternative embodiment of the present invention, the interactive session between the first user 120₁, 120₂, or 120_{N} and the second user 105 may occur in a chatroom environment via network 160 by use of general purpose computers and/or mobile devices. It should be appreciated that that there may be multiple second users 105 and first users 120_{N} who participate in the interactive session.

At step 350, administrator 110 generates at central server 115 at least one record associated with the first user 120₁, 120₂, or 120_{N} in a database in connection with the recovery plan. The record may contain any data related to the first user 120₁, 120₂, or 120_{N} including, but not limited to, contact information such as name, address, telephone number and email address, payment information such as credit number or check number, and recovery information relating to the first user's progress with respect to the twelve-steps of the substance abuse recovery program. The generated record allows the second user 105 to track the progress of the first user's substance abuse recovery and easily access and retrieve any information associated with the first user 120₁, 120₂, or 120_{N}. In an alternative embodiment of the present invention, the first user 120₁, 120₂, or 120_{N} or a third party may have access to the generated record.

The method 300 is concluded at step 360. However, it should be noted the method 300 may be repeated any number of times or for any number of reasons, e.g., for a multitude of users, periodically or as many times as users access the system 100.

In an alternative embodiment of the present invention, the system and method of substance abuse recovery may be performed in an environment that is more conducive to boosting the morale and well-being of an individual suffering from an addictive disease. For example, the recovery process may be implemented in a luxurious resort-like rehabilitation facility situated in a relaxing and therapeutic environment such as the ocean, mountains or other secluded countryside locale. An individual enrolled in a recovery program at a resort-like facility will likely boost his/her morale when compared to a similarly situated individual enrolled in a program held at a typical office meeting room or church. Overall, it is advantageous for an individual to enroll in a recovery program at a resort-like facility because the individual's resulting boost in morale will likely increase the success rate of the substance abuse recovery process.

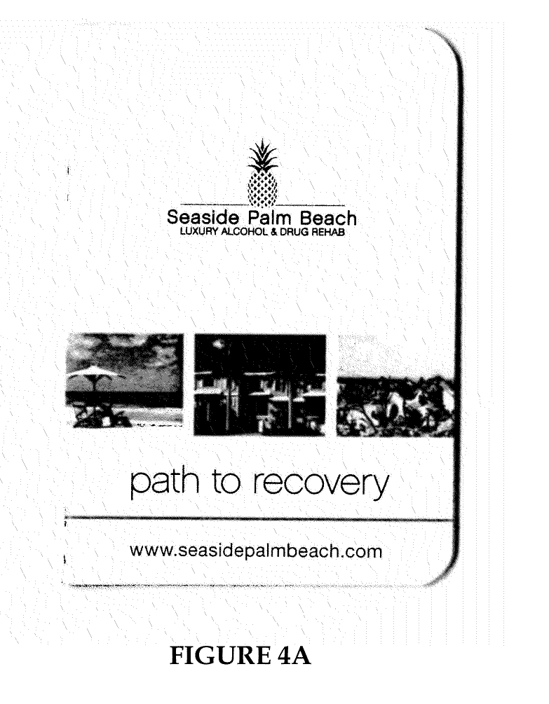

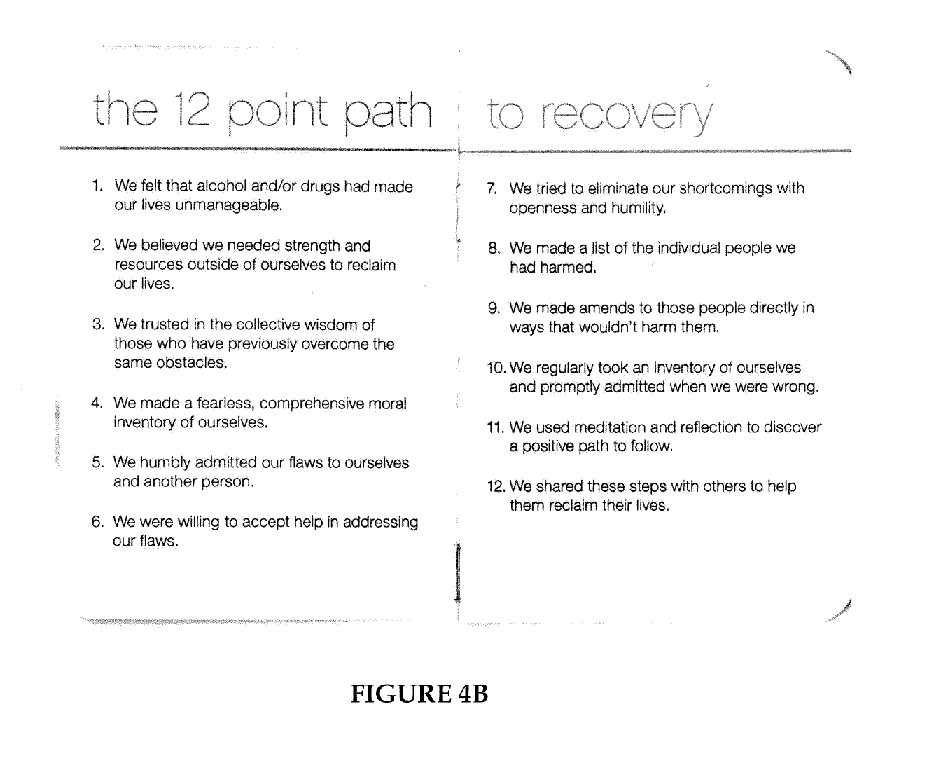

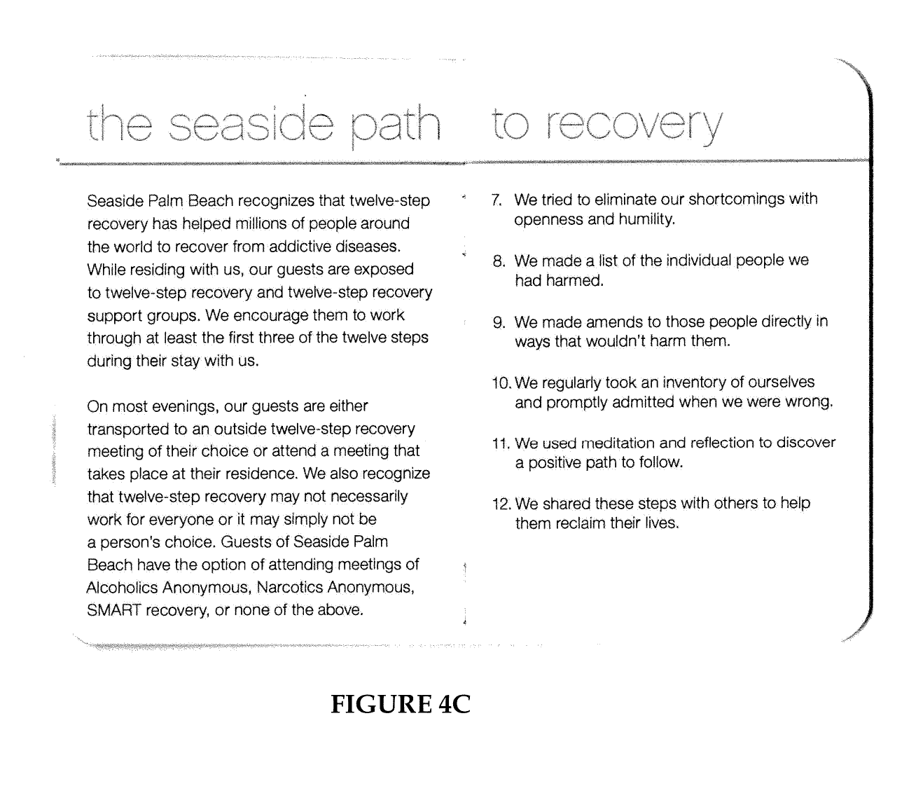

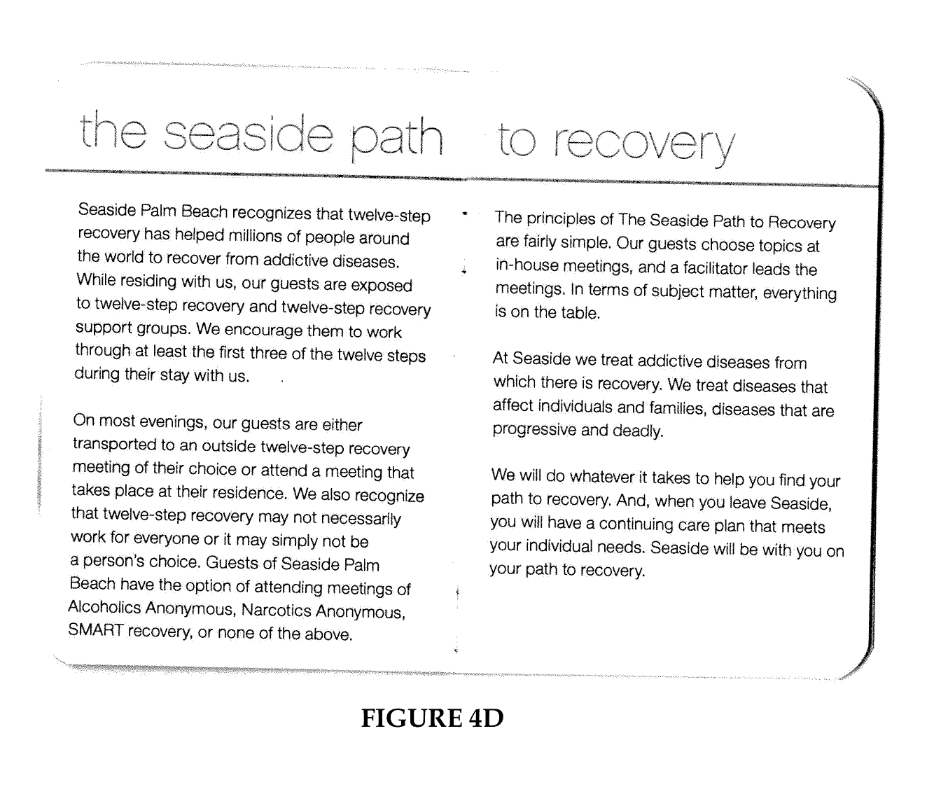

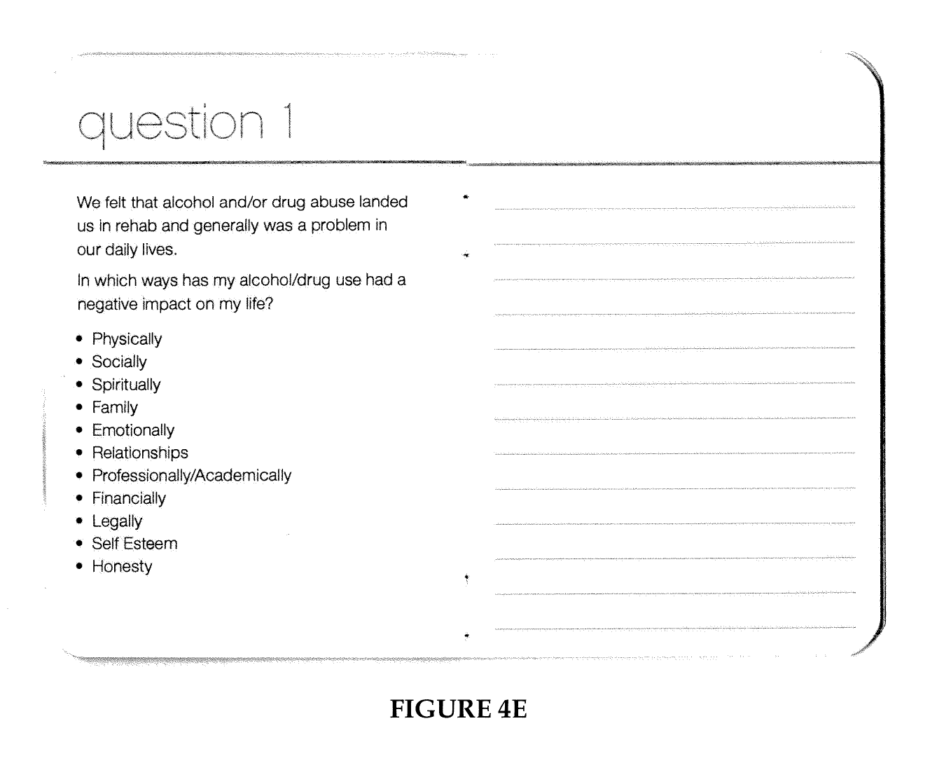

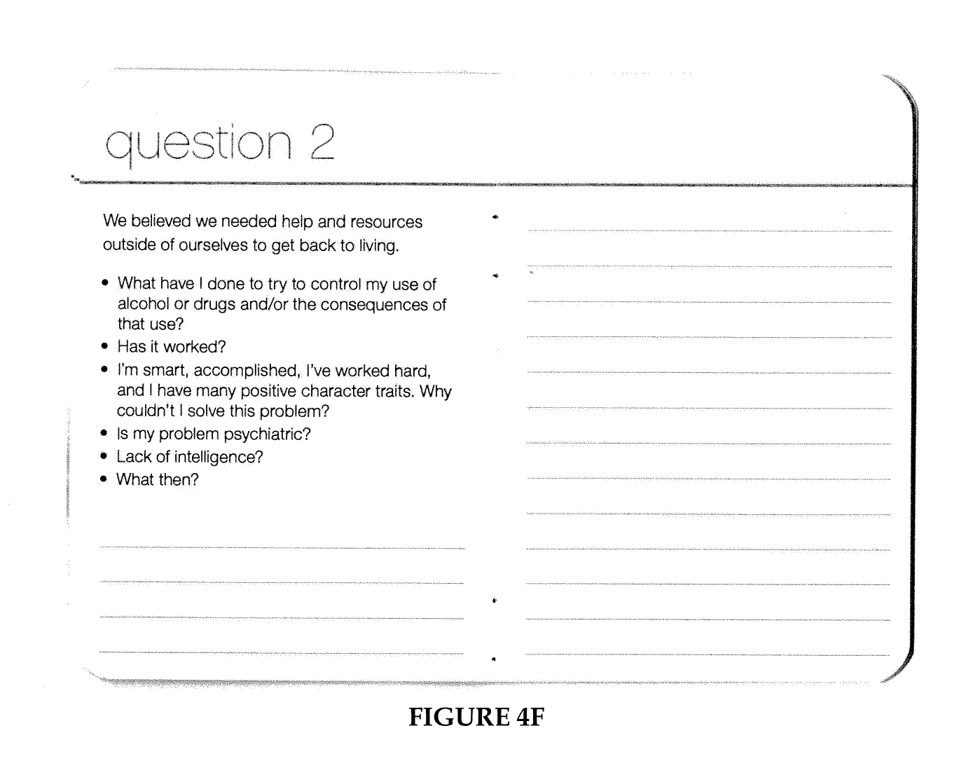

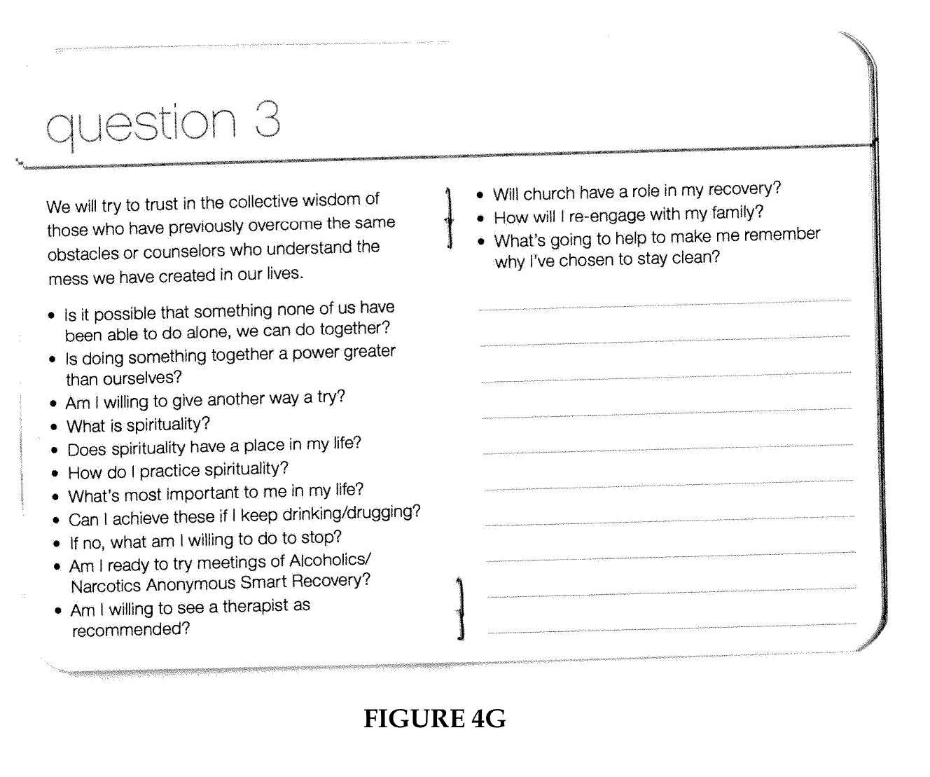

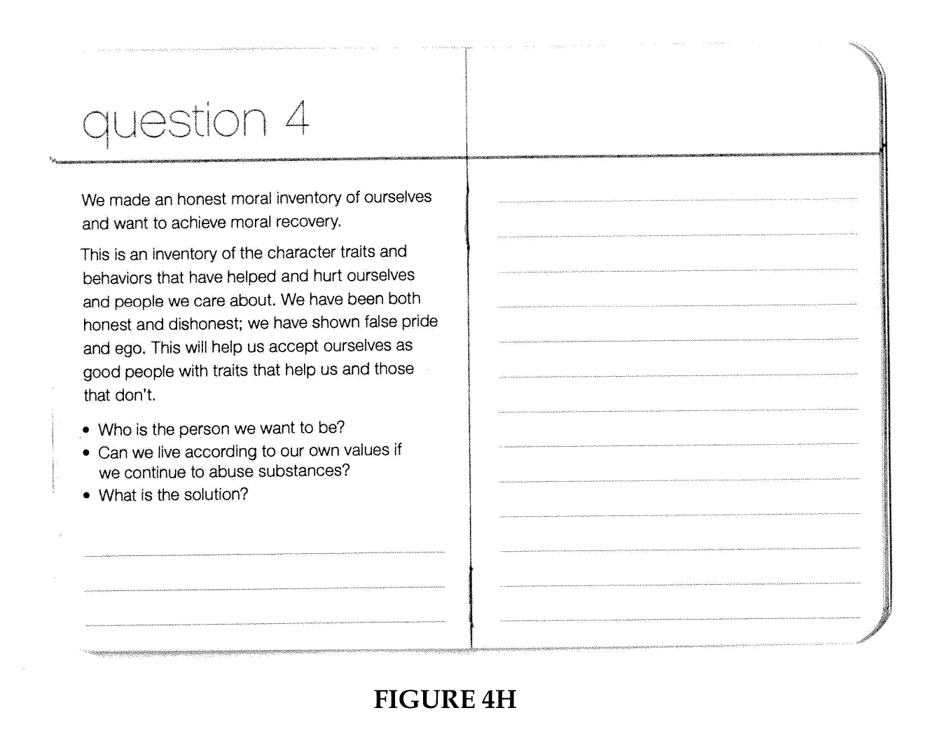

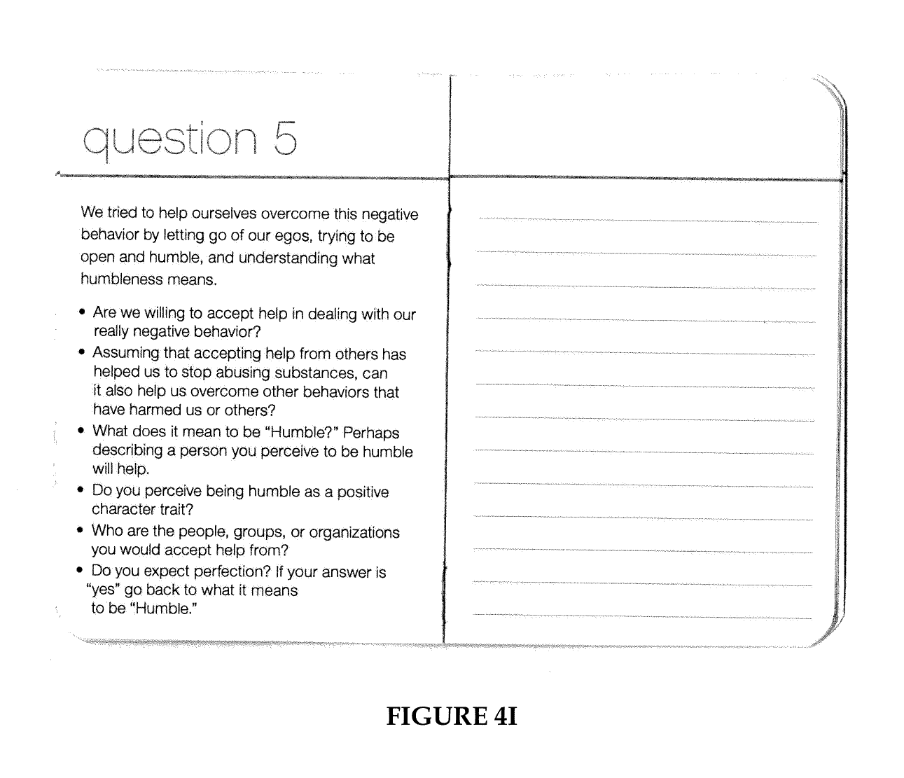

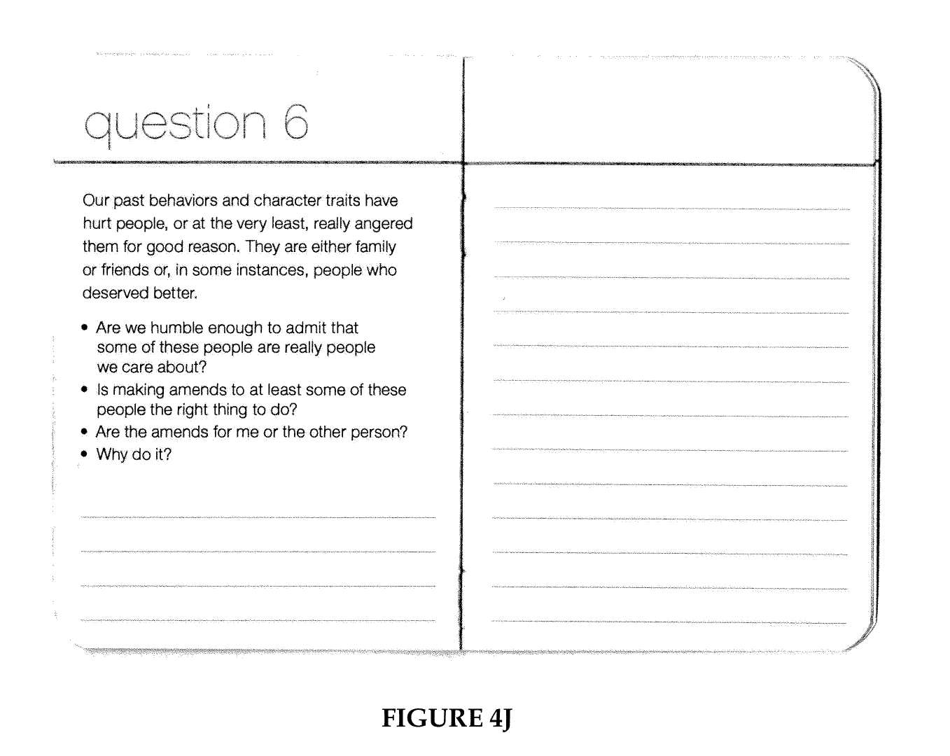

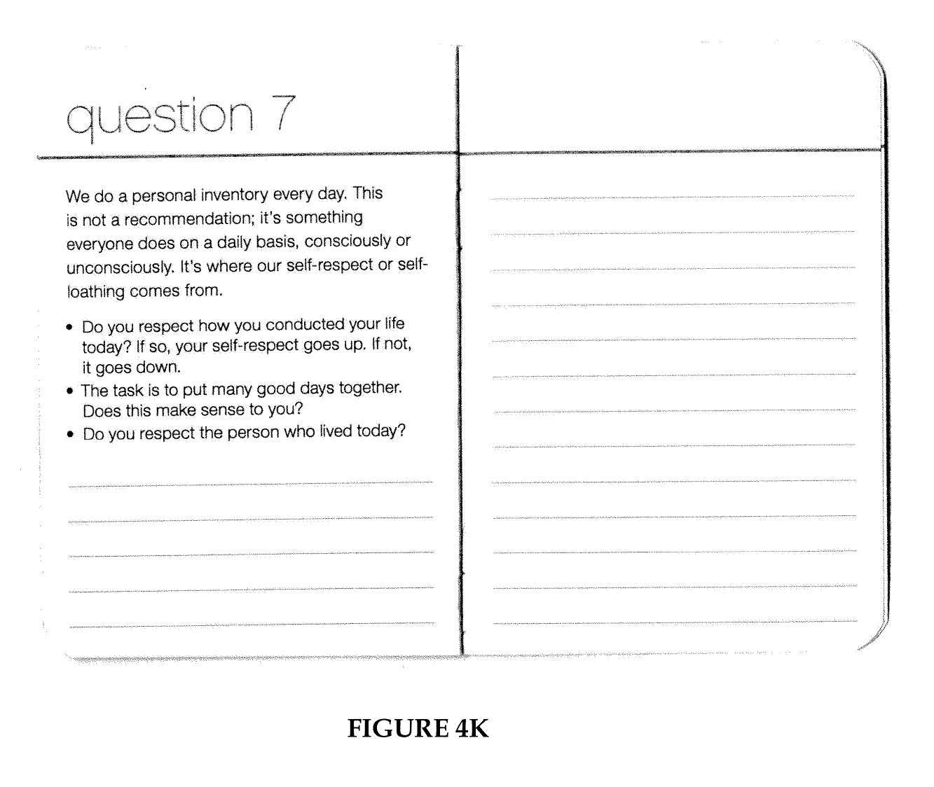

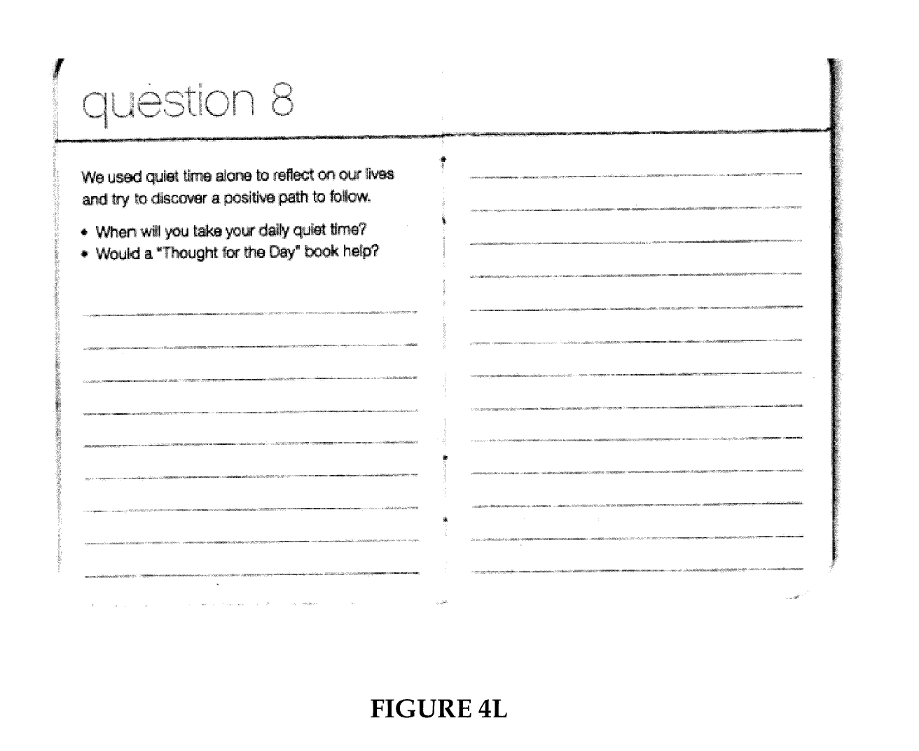

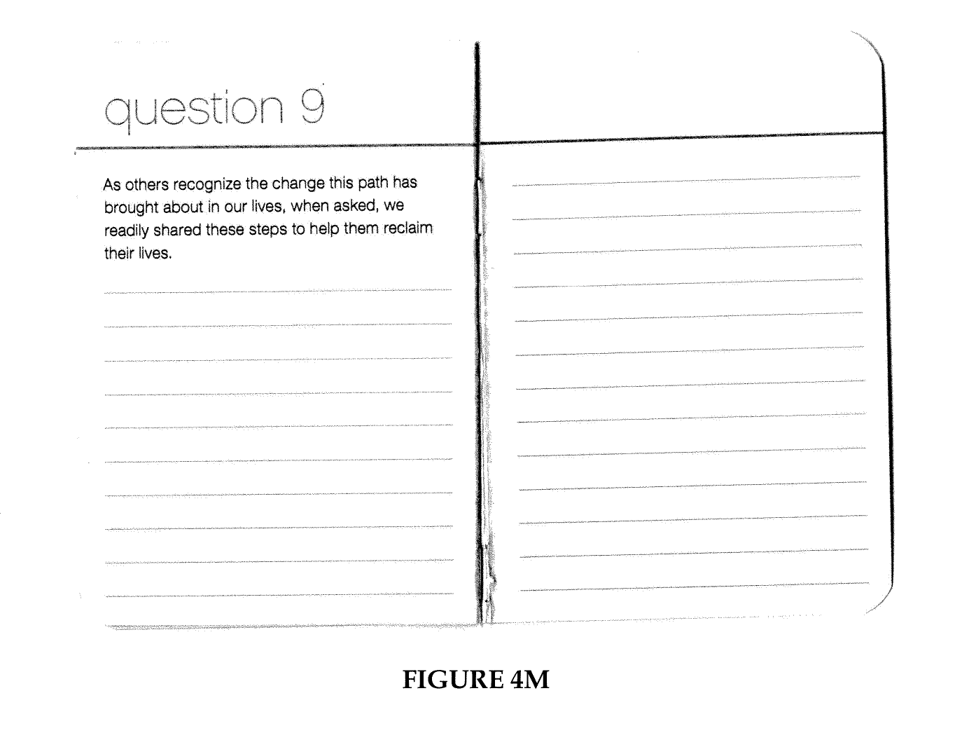

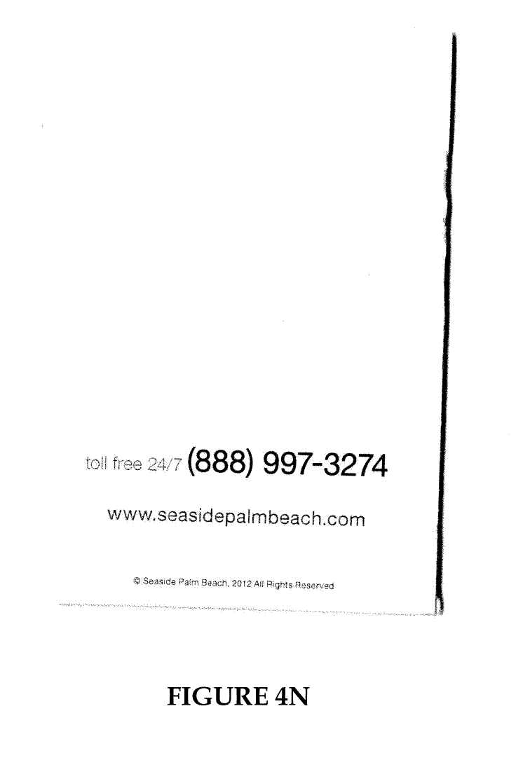

FIGS. 4A-4N depict various examples of a recovery plan to be used in a system and method for substance abuse recovery in accordance with embodiments of the present invention. In particular, FIGS. 4A-4N depict various exemplary embodiments of a book associated with a recovery plan as described in FIG. 3.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method of substance abuse recovery, the method comprising:
receiving a request for a recovery plan from at least a first user;
providing a book associated with the recovery plan to at least the first user;
administering an interactive session between at least the first user and at least a second user based on the recovery plan; and
generating, at a central server, at least one record associated with at least the first user in a database in connection with the recovery plan.

2. The method of substance abuse recovery of claim 1, wherein the at least second user is a health professional.

3. The method of substance abuse recovery of claim 1, wherein the recovery plan comprises receiving from the at least first user an acknowledgement that a substance has made the at least first user's life unmanageable.

4. The method of substance abuse recovery of claim 3, wherein the recovery plan comprises receiving from the at least first user a belief of a need for outside support to address the at least first user's unmanageable life.

5. The method of substance abuse recovery of claim 3, wherein the recovery plan comprises trusting by the at least first user at least another first user's input, wherein the at least another first user has previously overcome obstacles similar to those of the at least first user's substance abuse recovery.

6. The method of substance abuse recovery of claim 3, wherein the recovery plan comprises receiving from the at least first user an acknowledgement of a conducted moral inventory associated with the first user.

7. The method of substance abuse recovery of claim 3, wherein the recovery plan comprises conducting a regular inventory session by the at least first user.

8. The method of substance abuse recovery of claim 3, wherein the recovery plan comprises an admittance of at least one flaw from the at least first user to another user.

9. The method of substance abuse recovery of claim 3, wherein the recovery plan comprises a first user acceptance of help in addressing the at least one flaw.

10. The method of substance abuse recovery of claim 3, wherein the recovery plan comprises the first user's attempt to eliminate shortcomings in the substance abuse recovery through openness and humility.

11. The method of substance abuse recovery of claim 3, wherein the recovery plan comprises creating a list of users harmed by the first user.

12. The method of substance abuse recovery of claim 11, wherein the recovery plan comprises making amends by the first user to each user in the list of users.

13. The method of substance abuse recovery of claim 11, wherein the recovery plan comprises using meditation and reflection to discover a future positive path in the first user substance abuse recovery.

14. The method of substance abuse recovery of claim 11, wherein the at least first user shares at least one step of the recovery plan with at least another user.

15. A system of substance abuse recovery comprising:
a central server, accessible via a global computer network comprising a tangible computer readable medium comprising program instructions, wherein the program instructions are computer-executable to implement:
receiving a request for a recovery plan from at least a first user;
providing a book associated with the recovery plan to at least the first user;
administering an interactive session between at least the first user and at least a second user based on the recovery plan; and
generating, at the central server, at least one record associated with at least the first user in a database in connection with the recovery plan.

16. The system of substance abuse recovery of claim 15, wherein the at least second user is a health professional.

17. The system of substance abuse recovery of claim 15, wherein the recovery plan comprises receiving from the at least first user an acknowledgement that a substance has made the at least first user's life unmanageable.

18. The system of substance abuse recovery of claim 17, wherein the recovery plan comprises receiving from the at least first user a belief of a need for outside support to address the at least first user's unmanageable life.

19. The system of substance abuse recovery of claim 17, wherein the recovery plan comprises trusting by the at least first user at least another first user's input, wherein the at least another first user has previously overcome obstacles similar to those of the at least first user's substance abuse recovery.

20. The system of substance abuse recovery of claim 17, wherein the at least first user shares at least one step of the recovery plan with at least another user.
